(19) United States
(12) Patent Application Publication
(10) Pub. No.: US 2020/0238292 A1
(43) Pub. Date: Jul. 30, 2020

(54) STRIKING TOOL FOR USE IN A HIGH SPEED COMMINUTION MILL

(71) Applicants: ELEMENT SIX (UK) LIMITED, DIDCOT, OXFORDSHIRE (GB); ELEMENT SIX GMBH, BURGHAUN (DE)

(72) Inventors: PETER ROBERT BUSH, DIDCOT (GB); JONEE CHRISTINE PAREDES ZUNEGA, DIDCOT (GB); BERND HEINRICH RIES, BURGHAUN (DE); HABIB SARIDIKMEN, DIDCOT (GB)

(73) Assignees: ELEMENT SIX (UK) LIMITED, DIDCOT, OXFORDSHIRE (GB); ELEMENT SIX GMBH, BURGHAUN (DE)

(21) Appl. No.: 16/755,272

(22) PCT Filed: Dec. 20, 2018
(86) PCT No.: PCT/EP2018/086136

§ 371 Date: Apr. 10, 2020

(30) Foreign Application Priority Data
Dec. 22, 2017 (GB) 1721690.4

(51) Int. Cl. B02C 13/28; B02C 18/18

(52) U.S. Cl. CPC B02C 13/2804; B02C 13/282; B02C 18/18

(57) ABSTRACT

This disclosure relates to a striking tool for use in a high velocity, high impact energy comminution mill. The tool comprises an elongate body attachable at a first end to the comminution mill, and further comprises a wear resistant element for improving the wear resistance of the striking tool. The wear resistant element comprises a plurality of individual units.

### FIELD OF THE INVENTION

This disclosure relates to a striking tool for use in a high velocity, high impact energy comminution mill. Such a mill is typically used for crushing rock and minerals extracted from mines.

### BACKGROUND

Like High Pressure Grinding Rollers (HPGR), comminution mills are one of several ways employed to crush rocks and minerals. Rock formations enter the mill through a material inlet and exit the mill through a material outlet. As the rock formations pass through the mill, they encounter rotors and/or stators which operate to reduce the effective diameter of the formations. Many include pointed teeth designed to strike and fracture the incident rocks, thereby reducing the particle size from one grade to another. Blades of the rotors are subject to great forces and accordingly to intense wear and defects such as edge chips.

For example, EP 2 851 122B1 discloses a comminution device for mechanically comminuting material conglomerates consisting of materials of varying density and/or consistency. The device comprises a cylindrical comminution chamber containing a vertical stack of rotatable striking tools. The material inlet is located at the top of the chamber, and the material outlet located at the bottom of the chamber. Conglomerates pass through the comminution chamber primarily under gravity, travelling from the material inlet to the material outlet and impacting the striking tools on the way.

When each striking tool suffers extensive wear and/or defects, it often leads to catastrophic failure, which can in turn cause damage to other striking tools within the mill. Operation of the mill must halt and each damaged striking tool replaced.

### SUMMARY

It is an object of the invention to provide striking tools for such a comminution mill with improved wear resistance and fracture resistance, thereby extending the operational life and operational efficiency of the mill.

In one aspect of the invention, there is provided a striking tool for use in a high velocity, high impact energy comminution mill, said tool comprising an elongate body attachable at a first end to the comminution mill, and further comprising a wear resistant element for improving the wear resistance of the striking tool, the wear resistant element comprising a plurality of individual units.

The wear resistant element may extend from a second end, opposite the first end, towards the first end by at most 90% of a longitudinal extent of the striking tool.

The wear resistant element may be arranged to encompass a leading edge of the striking tool.

The wear resistant element may comprise a series of wear teeth arranged in side-by-side configuration.

The wear resistant element may be arranged on or in a first surface of the striking tool.

The wear resistant element may be arranged on or in first and second adjacent surfaces of the striking tool.

Optionally, the wear resistant element comprises a plurality of protrusions extending outwardly from the or each surface of the striking tool.

Optionally, the protrusions are inserts seated in correspondingly shaped recesses provided in the or each surface.

Preferably, the inserts have a rounded profile at or above the surface or each of the striking tool.

The protrusions may be arranged in a regular array across the or each surface.

The protrusions may be configured to be more closely packed nearer the second end.

Optionally, the striking tool further comprises elongate ribs extending outwardly from a surface of the striking tool.

The wear resistant element may comprise a series of plates arranged in side by side configuration, attached to the or each surface of the striking tool.

Optionally, the wear resistant element comprises polycrystalline diamond (PCD) material.

Preferably, the wear resistant element comprises cemented carbide material(s).

In a further aspect of the invention, there is provided a striking tool for use in a high speed comminution mill, said tool comprising an elongate body attachable at a first end to the high speed comminution mill, and further comprising a wear resistant element for improving the wear resistance of the striking tool, the wear resistant element comprising a wear resistant layer extending partially across the body to form a hard facing.

The wear resistant layer may have a pre-defined variable layer thickness covering two or more distinct zones of the body.

Optionally, the wear resistant element comprises polycrystalline diamond (PCD) material.

Preferably, the wear resistant element comprises cemented carbide material(s).

### BRIEF DESCRIPTION OF THE DRAWINGS

The invention will now be more particularly described, by way of example only, with reference to the accompanying drawings, in which:

FIG. 1 illustrates a perspective view of a prior art rotor shaft and striking tools;

FIG. 2 illustrates a perspective view of a first embodiment of a striking tool;

FIG. 3 illustrates a perspective view of a second embodiment of a striking tool;

FIG. 4 illustrates a perspective view of a third embodiment of a striking tool;

FIG. 5 illustrates a perspective view of a fourth embodiment of a striking tool;

FIG. 6 illustrates a perspective view of a fifth embodiment of a striking tool;

FIG. 7 illustrates a perspective view of a sixth embodiment of a striking tool;

FIG. 8 illustrates a perspective view of a seventh embodiment of a striking tool;

FIG. 9 illustrates a perspective view of an eighth embodiment of a striking tool

FIG. 10 illustrates an exploded perspective view of the eighth embodiment of a striking tool; and

FIG. 11 illustrates a perspective view of a ninth embodiment of a striking tool.

### DETAILED DESCRIPTION

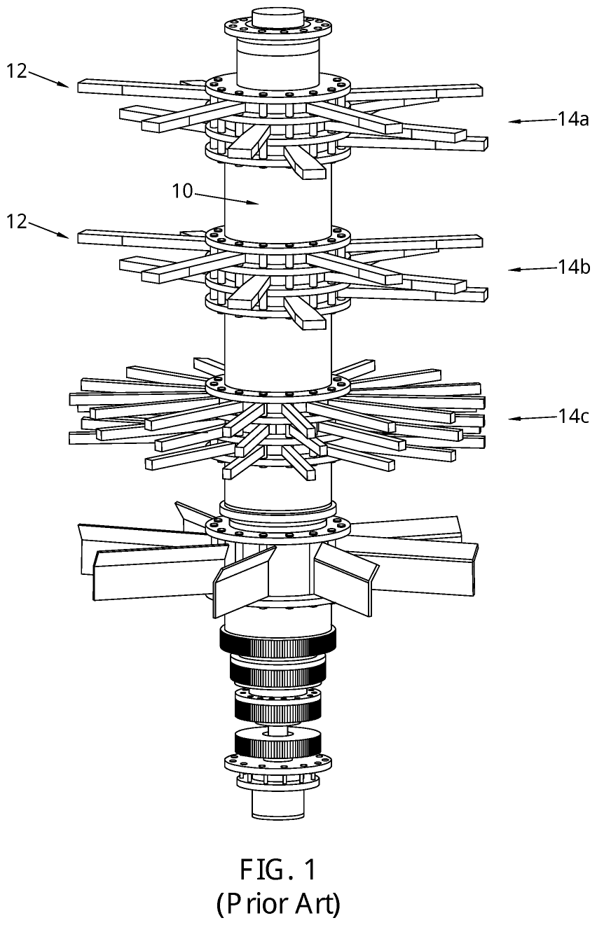

FIG. 1 illustrates a prior art rotor shaft 10 and plurality of striking tools 12, as disclosed in EP 2 581 122 B1. The striking tools 12 are mounted about the rotor shaft 10 such that they are rotatable about an axis of rotation extending through the rotor shaft 10. Rotor speeds are typically of the order of 800 to 1500 revolutions per minute. The rotor shaft 10 is housed within a cylindrical comminution chamber (not shown) of a high speed comminution mill. The comminution mill is ordinarily used for liberating valuable metal particles and mineral substance compounds integrated into thermal waste slag and ores. Exemplary starting material to be degraded or deagglomerated is basalt rock with length in the order of 300 mm, and iron ore rocks with length in the order of 150 mm.

The comminution chamber has a material inlet and material outlet. The rotor shaft 10 is arranged vertically, and material formations or conglomerates to be degraded or separated are fed into the top of the comminution chamber via the material inlet. Multiple sections 14a, 14b, 14c are provided axially along the length of the rotor shaft 10. Each section 14a, 14b, 4c contains a plurality of striking tools 12, which serve the purpose of breaking up the material supplied into the comminution chamber. Impact speeds of over 200 metres per second can be achieved. This invention relates only to the striking tools 12.

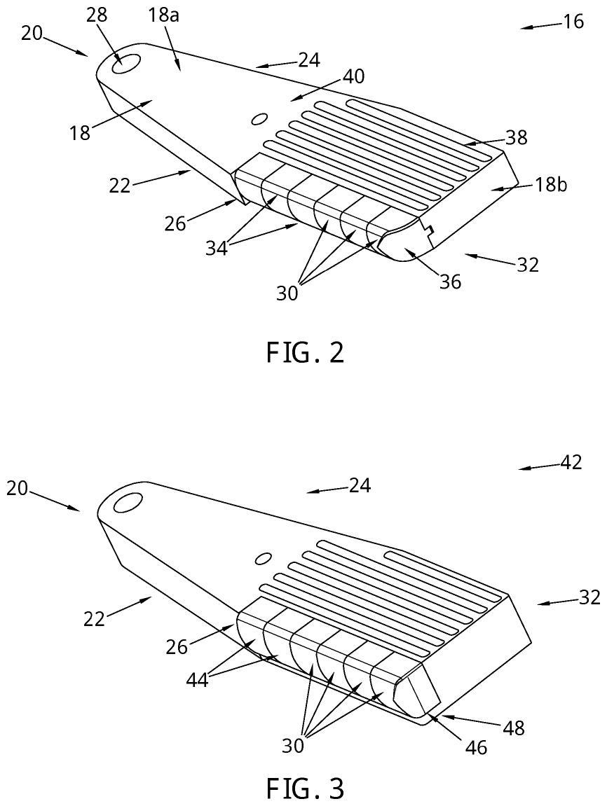

Turning now to FIG. 2, a first embodiment of a striking tool in accordance with the invention, is indicated generally at 16. The striking tool 16 comprises an elongate body 18 attachable at a first end 20 to the rotor shaft 10 of the high velocity, high impact energy comminution mill, and further comprising a wear resistant element, the wear resistant element comprising a plurality of individual units.

The way in which the body 18 attaches to or connects with the comminution mill is not relevant to the invention, and so any form of connection, join or attachment therebetween is intended.

The configuration of the striking tool 16 is directional in that it is radially non axisymmetric with respect to the rotor shaft 10. The striking tool 16 comprises a leading side 22 and a trailing side 24, defined with respect to the intended direction of rotation about the rotor shaft 10 in use.

In this embodiment, the striking tool 16 is a cuboid and generally rectangular in lateral cross-section. However, other shapes or forms of cross-section are also envisaged, for example, the striking tool 16 could be generally cylindrical, and therefore circular in lateral cross-section. Alternatively, the striking tool 16 may be a triangular prism, with a triangular lateral cross-section. Alternatively, the striking tool 16 may be a pentagonal prism, with a pentagonal lateral cross-section. Alternatively, the striking tool 16 may be a hexagonal prism, with a hexagonal lateral cross-section. Non-regular geometric 3D shapes are possible too. Clearly, surfaces may be planar or arcuate.

The body 18 of the striking tool 16 includes a substrate 25, which in this embodiment is steel. The steel may be case hardened. Materials other than or in addition to steel could be used instead. Ferrous and non-ferrous metals may be used. For example, the body 18 may comprise impregnated diamond in a metal matrix.

The body 18 may be monolithic or it may alternatively include a protective layer or hard casing over a core of a different material. Preferably, the material used for the core first material has a higher fracture toughness than the outer (i.e. protective layer) second material, whilst the second material has a higher hardness and wear resistance than the first material. However, since the striking tool 16 includes the wear resistant element, the opposite scenario is also possible, though not preferable; the second material has a higher fracture toughness than the first material, and the first material has a higher wear resistance than the second material.

The striking tool body 18 comprises two conjoined body portions, a first body portion 18a being substantially conical (with a rounded apex) in plan view and a second body portion 18b being rectangular in plan view. The second portion body 18b is circumferentially (i.e. laterally) narrower than the first body portion 18a such that there is a single stepped shoulder 26 at the transition between the first and second body portions 18a, 18b. The stepped shoulder 26 is only present on the lead side 22 of the striking tool 16 for reasons which will become apparent. On the trailing side 24, the striking tool 16 tapers laterally inwardly from a point A, just past the transition between the first and second body portions 18a, 18b.

A through-hole 28 is located in the first body portion 18a, at the first end 20, to enable the striking tool 16 to be mounted to the rotor shaft 10 using conventional means. This may, for example, include a mechanical hinge connection.

In this embodiment, the wear resistant element is provided by a plurality of wear teeth 30 arranged in side-by-side configuration along the leading side 22 of the striking tool 16. By positioning the wear teeth 30 along the leading side, protects the striking tool where the rate of material wear is highest. The wear teeth 30 extend from a second opposing end 32 of the striking tool 16 towards the first end 20, to approximately midway along the longitudinal extent of the striking tool 16.

Six wear teeth 30 are provided in this instance but more or less could be used. The number of wear teeth 30 and their physical extent along the length of the striking tool 16 is dependent on the anticipated wear scar or damage caused by the incident conglomerates and can be modified accordingly.

Each tooth 30 attaches to a body 18 of the striking tool 16 with a mating arrangement. In this embodiment, the teeth 30 are joined to the body 18 using braze. Alternatively, the wear teeth 30 may be removably mounted to the body for ease of replacement.

Each tooth 30 is a generally cubic block with filleted lead edges 34. The first tooth in the row abuts the stepped shoulder 26 between the first and second body portions 18a, 18b. The last tooth in the row, nearest the second end 32, is additionally curved inwardly towards the first end 20. The last tooth has a filleted outer edge 36 to supplement the filleted lead edges. The wear teeth 30 are offset radially inwardly with respect to the lead side 22 such that they do not project past the second body portion 18b in the direction of rotation.

Filleted or chamfered edges alleviates stress the critical regions where they impact the rock materials, thereby preventing or at least limiting fracture of the striking tool 16. Rather than use rounded corners, a hemispherical surface on the leading side also works well.

Each tooth 30 comprises wear resistant material, such as cemented carbide (e.g. cemented tungsten carbide), polycrystalline diamond (PCD) material, cubic boron nitride (cBN), polycrystalline cubic boron nitride (PCBN), or ceramics.

A plurality of elongate protective ribs 38 project outwardly from an upper planar surface 40 of the striking tool. These ribs 38 function to protect the striking tool body 18. Six ribs 38 are arranged in parallel and extend from the second end 32 to the artificial interface between first and second body portions 18a, 18b.

More or less ribs 38 could be used instead. Optionally, the ribs may extend across the striking tool body 18.

The ribs 38 comprise a low melting point carbide (LMC) material, characterised by its iron base. Exemplary materials are described in U.S. Pat. Nos. 8,968,834, 8,846,207 and 8,753,755. Alternatively, the ribs 38 may comprise cemented carbide or polycrystalline diamond (PCD) material, or other wear resistant material.

Subsequent Figures show variants of the striking tool. Where appropriate, similar parts are indicated by similar reference numerals. For brevity, only the key differences are described below.

In FIG. 3, a further embodiment of the striking tool is indicated at 42. Here, the wear teeth 44 are not offset inwardly with respect to the lead side 22. Unlike the embodiment shown in FIG. 2, the wear teeth 42 do project past the second body portion 18b in the direction of rotation.

Another difference is that each wear tooth 42 is supported on a lower side 46 thereof by the striking tool body 18. The body 18 includes a short support wall 48, which extends circumferentially outward from a lower side of the second body portion 18b. This support wall 48 reduces the risk of a wear tooth 42 from being knocked from the body 18 as incident rocks impact the striking tool 42 from above. The wear teeth 42 are connected to the body 18 using brazing. The depth (measured axially) of the striking tool has been increased to facilitate this connection.

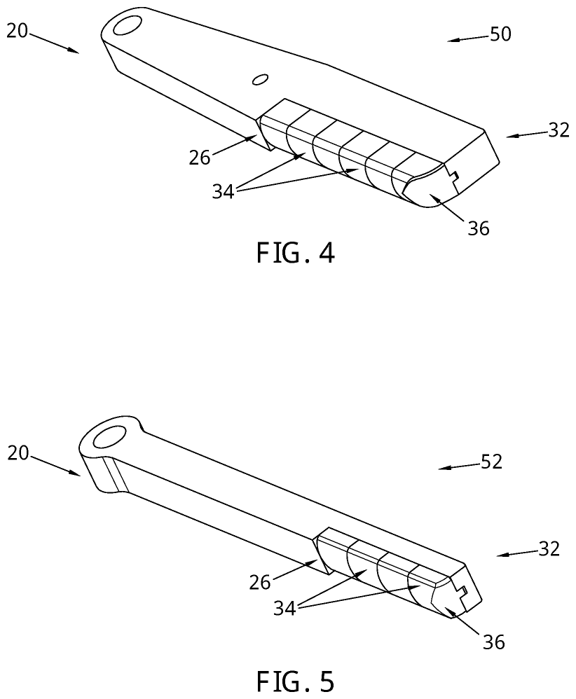

FIG. 4 indicates a further embodiment of the striking tool indicated at 50, which is based on the embodiment of FIG. 2, but which is approximately half the breadth.

In FIG. 5, the breadth of another embodiment of the striking tool 52 has been decreased again, by approximately half. Four wear teeth 34 are provided, connected to the body 18 of the striking tool 52, again using a mating arrangement.

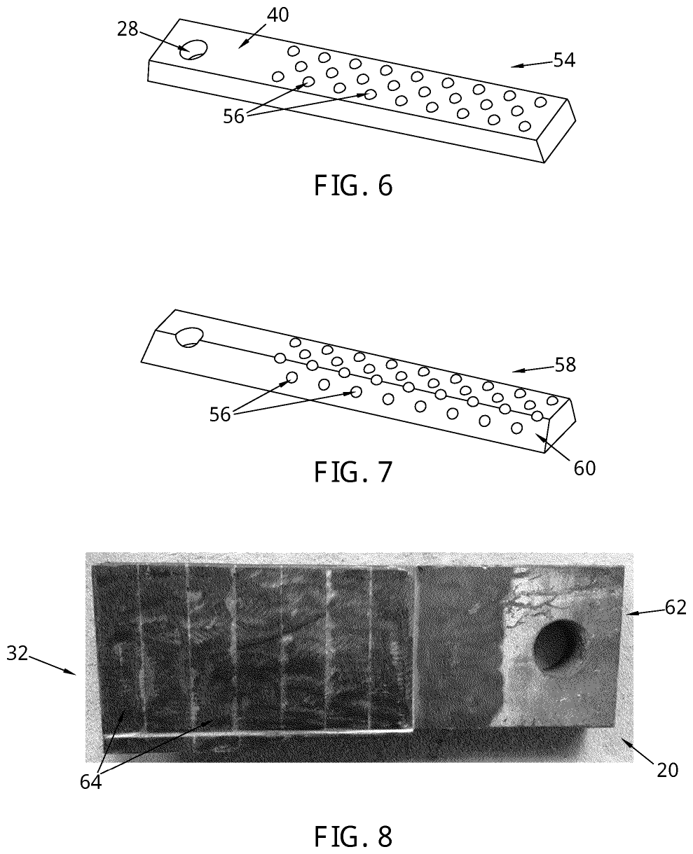

In FIG. 6, the striking tool 54 comprises an elongate block with rectangular lateral cross-section. In this embodiment, the wear resistant element is provided by a plurality of protrusions or studs 56 extending outwardly from the upper planar surface 40 of the striking tool 54. The protrusions 56 are arranged in an array across the surface 40, distinguished by their regular spacing. However, they could be configured to be more closely packed, particularly but not necessarily nearer the second end 32. The protrusions 56 are inserts seated in correspondingly shaped recesses provided in the surface 40.

The purpose of the protrusions 56 is to act as a shield to protect the substrate 25. They also improve the cutting efficiency of the striking tool too. It is thought that when impacting the incident rock, the reduced area of the protrusions (compared to the body 18), concentrates the stress in the rock to a greater degree than the otherwise planar surface of the body 18.

As with the wear resistance element in any of the embodiments included in this description, the material of the protrusions preferably comprises cemented carbide or polycrystalline diamond (PCD) material. Other wear resistant materials could be used too.

In this embodiment, the inserts 56 have a rounded profile at or above the surface 40. It is conceivable that inserts with other shaped profiles could be used instead, for example, they may be parabolic or truncated. Equally, the protrusions may be inserts that are spherical, hemispherical inserts, cubic, cuboid and the like.

The inserts 56 are secured to the body 18 using brazing, but alternatively press-fitting, shrink fitting, gluing or any other means of attachment could be used instead.

In FIG. 7, the wear resistant element is again provided by a plurality of protrusions 56. However, in this embodiment, the striking tool 58 comprises an elongate block with trapezoidal lateral cross-section. The widest surface forms the lower most surface of the striking tool 58. Protrusions 56 are provided on a second planar surface 60 in addition to the upper planar surface 40. The second planar surface 60 is on the leading side 22 of the striking tool 58.

In FIG. 8, the striking tool 62 comprises an elongate block with rectangular lateral cross-section. In this embodiment, the wear resistant element is provided in the form of rectangular plates 64. The plurality of plates 64 extend across the upper planar surface of the striking tool 62, in side-by-side configuration, from the second end 32 towards the first end 20. The plates 64 extend to approximately 60% of the longitudinal extent of the upper surface 40. There are seven plates 64 shown in the FIG. 8 but it is clear that more or less could be provided as required. Each plate 64 is attached to the body 18 of the striking tool 62 using brazing, although other forms of attachment could be used.

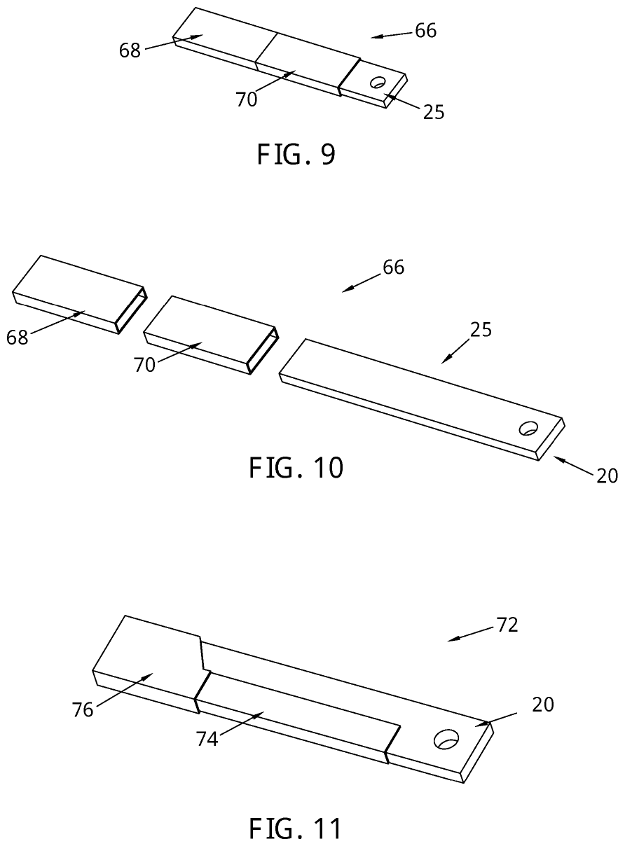

In FIGS. 9 and 10, the striking tool 66 comprises an elongate block with rectangular lateral cross-section. The wear resistant element is provided in the form of a carbide cap 68 covering a portion of the substrate 25, and a sleeve 70 covering a second (different) portion of the substrate 25, adjacent to the first portion. The carbide cap 68 extends from the second end 32 towards the first end 20, and extends along approximately 30% of the longitudinal extent of the striking tool 66. The sleeve 70 is a case hardened steel casing. The sleeve 70 has approximately the same length as the carbide cap 68, but it is positioned midway along the striking tool 66, such that the total extent of the wear resistant element is about 60% along the length of the striking tool 66.

In FIG. 11, the striking tool 72 comprises an elongate block with rectangular lateral cross-section. The wear resistant element is provided in the form of a protective layer extending partially across the substrate 25. The steel substrate acts as a tough core material that is able to withstand the impact and vibration loading onto the striking tool, whereas the protective layer provides abrasion resistance to reduce wear of the striking tool.

For the protective layer, a standard hard facing or LMC material (mentioned earlier) could be used. Various techniques may be used to acquire desirable material properties at or near the surface: nitriding, carburization, case hardening, and/or laser treatment.

The protective layer is provided in two distinct zones. A first zone 74 has a first pre-defined thickness whereas the second zone 76 has a second pre-defined thickness, the second zone 76 having a greater thickness than the first zone 74. The second zone 76 is located at the second end of the striking tool 72. This targeted approach to layering ensures that the protective layer is provided only where it is most needed for abrasion resistance, ultimately in order to reduce material costs.

While this invention has been particularly shown and described with reference to embodiments, it will be understood by those skilled in the art that various changes in form and detail may be made without departing from the scope of the invention as defined by the appended claims.

Furthermore, although rock material incident on the striking tools has been described as being conglomerates, it is not intended to be limiting on the invention. Conglomerates, agglomerates or any other type of rocks or minerals of similar size and magnitude could equally be used with this invention.

Although the wear teeth have been described as extending partially across the breadth of the striking tool, the wear teeth may alternatively extend across the full breadth of the striking tool 16. In such an embodiment, each wear tooth may include a securing ring through which a locking pin passes to secure the wear teeth to the body of the striking tool.

In any of the embodiments described herein, the wear resistant element may extend from the second end of the striking tool, towards the first end, along the full length of the striking tool (i.e. 100% of the longitudinal extent). Optionally, the wear resistant element may extend from the second end towards the first end by at most 90%, at most 80%, at most 70%, at most 60%, at most 50%, at most 40%, at most 30%, at most 20%, or at most 10% of the longitudinal extent of the striking tool.

Any combination of features from the various embodiments is envisaged. For example, protrusions 56 may be used in combination with wear teeth 30 as a substitute for (or in addition to) the protective ribs 38.

The striking tool described herein has superior wear resistance and fracture resistance to incident rocks and minerals being processed through a high velocity, high impact energy comminution mill.

Certain standard terms and concepts as used herein are briefly explained below.

As used herein, polycrystalline diamond (PCD) material comprises a plurality of diamond grains, a substantial number of which are directly inter-bonded with each other and in which the content of the diamond is at least about 80 volume per cent of the material. Interstices between the diamond grains may be substantially empty or they may be at least partly filled with a filler material or they may be substantially empty. The filler material may comprise sinter promotion material.

PCBN material comprises grains of cubic boron nitride (cBN) dispersed within a matrix comprising metal, semi-metal and or ceramic material. For example, PCBN material may comprise at least about 30 volume per cent cBN grains dispersed in a binder matrix material comprising a Ti-containing compound, such as titanium carbonitride and or an Al-containing compound, such as aluminium nitride, and or compounds containing metal such as Co and or W. Some versions (or “grades”) of PCBN material may comprise at least about 80 volume per cent or even at least about 85 volume per cent cBN grains.

1. A striking tool for use in a high velocity, high impact energy comminution mill, said tool comprising an elongate body attachable at a first end to the comminution mill, and further comprising a wear resistant element for improving the wear resistance of the striking tool, the wear resistant element comprising a plurality of individual units.

2. The striking tool as claimed in claim 1, in which the wear resistant element extends from a second end, opposite the first end, towards the first end by at most 90% of a longitudinal extent of the striking tool.

3. The striking tool as claimed in claim 1, in which the wear resistant element is arranged to encompass a leading edge of the striking tool.

4. The striking tool as claimed in claim 3, in which the wear resistant element comprises a series of wear teeth arranged in side-by-side configuration.

5. The striking tool as claimed in claim 1, in which the wear resistant element is arranged on or in a first surface of the striking tool.

6. The striking tool as claimed in claim 5, in which the wear resistant element is arranged on or in first and second adjacent surfaces of the striking tool.

7. The striking tool as claimed in claim 5, in which the wear resistant element comprises a plurality of protrusions extending outwardly from the or each surface of the striking tool.

8. The striking tool as claimed in claim 7, in which the protrusions are inserts seated in correspondingly shaped recesses provided in the or each surface.

9. The striking tool as claimed in claim 8, in which the inserts have a rounded profile at or above the surface or each of the striking tool.

10. The striking tool as claimed in claim 7, in which the protrusions are arranged in a regular array across the or each surface.

11. The striking tool as claimed in claim 7, in which the protrusions are configured to be more closely packed nearer the second end.

12. The striking tool as claimed in claim 1, further comprising elongate ribs extending outwardly from a surface of the striking tool.

13. The striking tool as claimed in claim 5, in which the wear resistant element comprises a series of plates arranged in side by side configuration, attached to the or each surface of the striking tool.

14. The striking tool as claimed in claim 1, in which the wear resistant element comprises polycrystalline diamond (PCD) material.

15. The striking tool as claimed in claim 1, in which the wear resistant element comprises cemented carbide material(s).

16. The striking tool for use in a high speed comminution mill, said tool comprising an elongate body attachable at a first end to the high speed comminution mill, and further comprising a wear resistant element for improving the wear resistance of the striking tool, the wear resistant element comprising a wear resistant layer extending partially across the body to form a hard facing.

17. The striking tool as claimed in claim 16, wherein the wear resistant layer has a pre-defined variable layer thickness covering two or more distinct zones of the body.

18. The striking tool as claimed in claim 16, in which the wear resistant element comprises polycrystalline diamond (PCD) material.

19. The striking tool as claimed in claim 16, in which the wear resistant element comprises cemented carbide material(s).
